(19) United States
(12) Patent Application Publication
(10) Pub. No.: US 2011/0068589 A1
(43) Pub. Date: Mar. 24, 2011

(54) ADJUSTABLE GATE LATCHING SYSTEMS

(76) Inventor: J. Harold Fieldberg, Medicine Hat (CA)

(21) Appl. No.: 12/758,804

(22) Filed: Apr. 13, 2010

Related U.S. Application Data
(60) Provisional application No. 61/245,319, filed on Sep. 24, 2009.

(51) Int. Cl. E05C 3/16

(52) U.S. Cl. 292/235

(57) ABSTRACT

An adjustable gate latching system is disclosed herein for tightly securing a flexible gate to a stationary fence that contains animals therein. The device comprises a stationary attacher means; a u-shaped member; a lever; and a flexible cable and/or chain. The device is rotatable and used to open and close the fence to maximize efficiency and user-comfort while performing the task.

### CROSS-REFERENCE TO RELATED APPLICATION

The present application is related to and claims priority from prior provisional application Ser. No. 61/245,319, filed Sep. 24, 2009 which application is incorporated herein by reference.

### BACKGROUND OF THE INVENTION

1. Field of the Invention

The present invention relates generally to the field of fasteners and more specifically relates to gate fasteners for use with flexible wire gates.

2. Description of the Related Art

Fences are used to provide an artificial enclosure means for livestock as a containment means to protect the animals from harm or harming others. Fence gates are an integral part of any farm fence. The fence gate keeps the livestock securely in the proper pasture in which they are fenced but also allows easy access for the farmer and equipment to also enter therein. Typically, flexible farm gates have horizontal barbed wires affixed to a vertical movable post that is attachable to a fixed perimeter fence end post in order to close the fenced portion. The movable post may be unattached to open the flexible gate allowing ingress and egress of individuals, animals and equipment. A conventional gate fastener is typically made of a simple wire loop that fits around both the flexible gatepost and the fixed fence end post that it is fastened to. These loops must be very tight to maintain the gate in a closed position so the animals cannot escape. Difficulties often occur when an individual is trying to open or close the gate via the wire loop due to its inherent tightness. Typically, it is a difficult and time-consuming task to lift or loosen the tightened loop and the user's hands and fingers may be pinched or otherwise injured in this process.

Various attempts have been made to solve the above-mentioned problems such as those found in U.S. Pat. Nos. 1,391,578; 2,770,482; 3,847,425; 3,667,729; 6,241,217; 3,799,595; 5,876,075; 3,450,187; 3,237,922; and 3,891,254. Although these inventions have tried to solve the problem of creating a convenient gate fastener they do not appear to provide a gate fastener comprising very few parts that is inexpensive, durable and easy to install and to use. This prior art is representative of gate fastening devices. None of the above inventions and patents, taken either singly or in combination, is seen to describe the invention as claimed.

Ideally, a gate fastener should be easy to install, easy to use, comprise a minimum of moving parts and be manufactured at a modest expense. Thus, a need exists for a reliable, durable, inexpensive, and easy to install gate fastener to avoid the above-mentioned problems.

### BRIEF SUMMARY OF THE INVENTION

In view of the foregoing disadvantages inherent in the known gate fastener art, the present invention provides a novel gate fastener system. The general purpose of the present invention, which will be described subsequently in greater detail is to provide a gate fastener that comprises very few parts, is inexpensive, easy to install and easy to use.

A gate latching system is disclosed herein for tightly securing a fence post to a gate post comprising: at least one stationary attacher comprising a nail or lag screw; a u-shaped member including two symmetrical portions having a plurality of apertures located through each of the symmetrical portions; a lever; and a cable or chain comprising two ends. The u-shaped member and the lever together comprise a moment arm assembly. The moment arm assembly is rotatable about the stationary attacher to decrease or increase the tension on the cable to open or close the flexible wire gate via leverage action.

The cable, if used, may be looped through at least one aperture as a tightening means for securing a flexible gate to a stationary fence. The u-shaped member comprises a center-line axis as an extension of the lever that is perpendicularly orientated to a vertical center-line axis of the stationary fence end-post. The lever is coupled to the u-shaped member for rotating about at least one stationary attacher used to couple the u-shaped member to the flexible wire fence. When the moment arm assembly is moved to an upright position, it will decrease the tension on the cable around the flexible gate post and the cable can then be lifted off or from around the flexible gate post. When the moment arm assembly is brought to a horizontal position by downward movement, the tension on the cable is increased, the cable is tightened around the flexible gate post and the gate is thereby secured.

A kit is embodied herein for the gate latching system comprising: a moment arm assembly, at least two stationary attachers (nails, lag screws or other fastening means), a cable and optionally and optionally a user instruction manual. The present invention may be manufactured, shipped, and sold a kit.

In accordance with the embodiments of the present invention a preferred method of using a gate latching system to secure a flexible wire gate to a stationary wire fence is also disclosed herein preferably comprising the steps of: attaching a moment arm assembly including a lever and a u-shaped member to a flexible gate post via stationary attachers; threading a cable through at least one aperture located on the u-shaped member to form an anchor means; rotating the moment arm assembly about the attacher to tighten the cable bringing the flexible gate post adjacent to a stationary fence end-post thereby closing a fencing perimeter. Further, optionally unsecuring the flexible gate from a stationary fence may be accomplished by rotating the moment arm assembly about the attacher(s) to loosen the cable withdrawing the flexible gate post from the adjacent stationary fence end-post thereby opening the fencing perimeter.

The present invention holds significant improvements and serves as a gate fastener system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, adjustable gate latching systems, constructed and operative according to the teachings of the present invention.

FIG. 1 shows a perspective view illustrating an adjustable gate latching system(s) in an opened and closed ‘in-use’ position according to an embodiment of the present invention.

FIG. 2 is another perspective view illustrating moment arm assemblies of the adjustable gate latching systems according to embodiments of the present invention of FIG. 1.

FIG. 3A is a perspective view illustrating a u-shaped member comprising apertures using a chain as a adjustable tightening means according to an alternate embodiment of the present invention of FIG. 1.

FIG. 3B is a perspective view illustrating another u-shaped member comprising apertures using a cable as a adjustable tightening means according to an embodiment of the present invention of FIG. 1.

FIG. 4 is a top perspective view illustrating the adjustable gate latching systems in a closed condition (‘in-use’ position) according to an embodiment of the present invention of FIG. 1.

FIG. 5 is a flowchart illustrating a method of use according to an embodiment of the present invention of FIGS. 1-4.

The various embodiments of the present invention will hereinafter be described in conjunction with the appended drawings, wherein like designations denote like elements.

### DETAILED DESCRIPTION

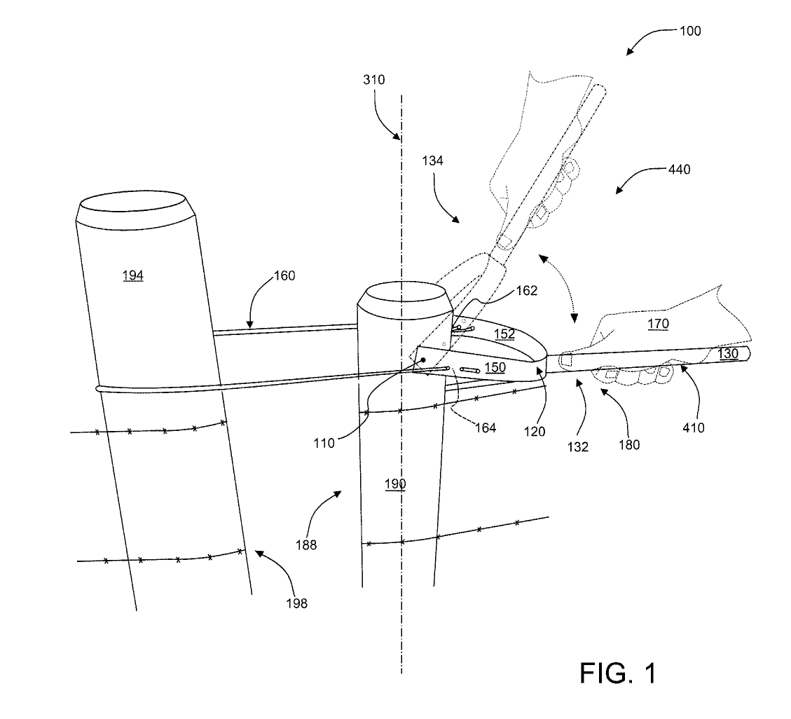

As discussed above, embodiments of the present invention relate to a fastening device and more particularly to a gate fastener as used to improve the efficiency and convenience for opening and closing wire fences with flexible wire gates. Referring to the drawings by numerals of reference there is shown in FIG. 1, a perspective view illustrating an adjustable gate latching system(s) 100 in a closed ‘in-use’ condition 180 according to an embodiment of the present invention. Further, in dotted lines is illustrated an opening motion that the present invention would rotate through to decrease the tension in cable 160 allowing the distance between flexible gate post 194 and stationary fence end post 190 to increase providing an opening in stationary fence 188.

Adjustable gate latching systems 100 of the present invention preferably comprises at least one stationary attacher 110; u-shaped member 120 (including first symmetrical portion 150 and second symmetrical portion 152); and lever 130 removably attached to cable 160 or alternately chain 158. Cable 160 and chain 158 are considered to be flexible for use. First symmetrical portion 150 and second symmetrical portion 152 comprise the two symmetrical halves of u-shaped member 120 for ease of explaining spatial relationship(s) within the present invention.

First symmetrical portion 150 and second symmetrical portion 152 of u-shaped member 120 within the present embodiment have a plurality of aperture(s) 140 (preferably three on each side) each comprising a through-hole located through each of first symmetrical portion 150 and second symmetrical portions 152. Aperture(s) 140 are of sufficient size to receive cable 160, having preferred dimensions of about 54″ long, using a 3/32″ nylon-coated type of cable 160. Cable 160 is secured by threading through aperture 140, back through another of aperture 140 and through yet another aperture 140, whereby first cable end 162 is inserted through the formed-loop thereby securing cable 160 to u-shaped member 120. In the preferred embodiment cable 160 is attached using three apertures 140, as described, allowing for suitable adjustment as required and is then knotted creating a friction-grip means.

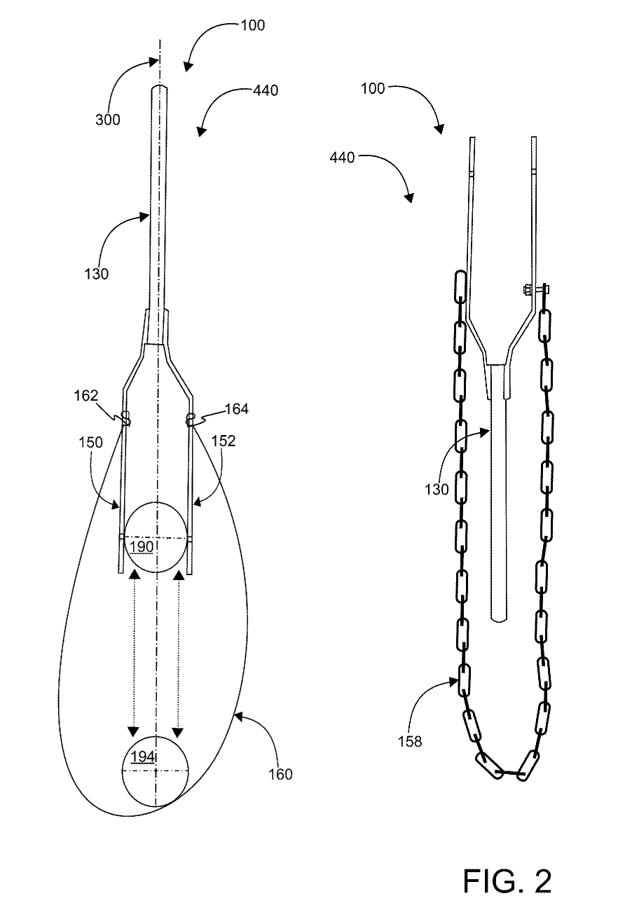

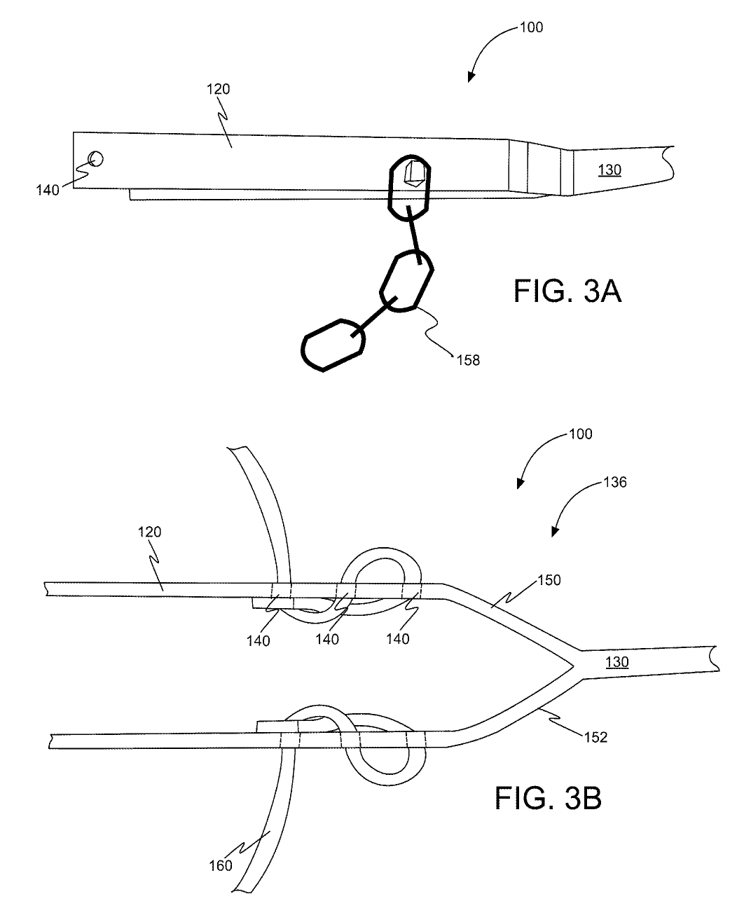

In an alternate embodiment, shown in FIGS. 2 and 3A, using chain 158 as a securing means, chain 158 may be welded or otherwise secured and the loose end slipped over a diagonal bolt head to create the securement means. A specialty bolt head is used (longer up than down), the wide side of the head measuring about ½″ and 5/16 on the other, thereby allowing chain 158 to be slipped over, but dutifully secured when chain 158 is pulled horizontal (parallel and adjacent to u-shaped member 120). In this particular embodiment, chain 158 may be effectively shortened or lengthened by placing a different link on the bolt head. Bolts within the alternate embodiment may measure 5/16″×1¼″ and use a 5/16″ lock nut. Chain 158 is preferably ⅜″ and comprises an overall length of about 44″. The above-mentioned lengths, widths, sizes, and dimensions are understood to be exemplary and are not intended to be limiting, but rather provide a sufficient enablement whereby the present invention may be duplicated for use. With respect to the attachment of chain 158 at the position of the adjustable bolt head, the bolt has a lock nut on the inside and also preferably has another nut on the outside where the head is located. This nut (preferably 5/16″ also) is a sufficient distance from the head of the bolt to allow the chain link to be looped over it.

Lever 130, provides at least a portion of the necessary levering means within the present invention thereby providing ease of use for an individual using (opening and/or closing) gate latching system 100. Lever 130 is coupled to u-shaped member 120 within the present embodiment to form moment arm assembly 136, thereby effectively increasing the length of the moment arm. Lever 130 preferably comprises a round profile enabling the device to be easily lifted and gripped without placing the fingers in a position under lever 130 (handle means) which may cause injuries to the fingers and/or hand when flexible gate 198 is being opened and/or closed. Cable 160 may be removably coupled via looping or tying means to moment arm assembly 136 and held securely via looping through aperture(s) 140. Moment arm assembly 136 increases the moment arm of the system increasing leverage and decreasing effort required to open/close flexible gate 198.

Cable 160 in this particular embodiment comprises first cable end 162 and second cable end 164; wherein cable 160 is looped through at least one aperture 140, as previously mentioned as a tightening means for securing stationary fence end post 190 to flexible gate post 194. Lever 130 is coupled to u-shaped member 120 for rotating about at least one stationary attacher 110 used to couple u-shaped member 120 to stationary fence end post 190, as shown in the present figure. Aperture(s) 140 are of sufficient size to receive stationary attacher 110, as shown. Aperture(s) 140 for receiving exactly two stationary attachers 110 (one each on each side of stationary fence end post 190) are located nearest the ‘open end’ of u-shaped member 120 allowing uniform rotation about stationary attachers 110 coupling adjustable gate latching system 100 to stationary fence end post 190.

U-shaped member 120 and lever 130 form moment arm assembly 136, as previously mentioned. Moment arm assembly 136 is preferably rotatable about stationary attacher 110 by at least one user 170, such as when a farmer/rancher is opening/closing flexible gate 198 to stationary fence end post 190 of stationary fence 188 to keep livestock substantially contained within the perimeter of stationary fence 188. In this way the present invention may be used as an efficient, safe, user-friendly gate latching means. Further, the device described herein provides a novel inventive fastener that avoids ‘snapping’ upon opening and/or closing actions.

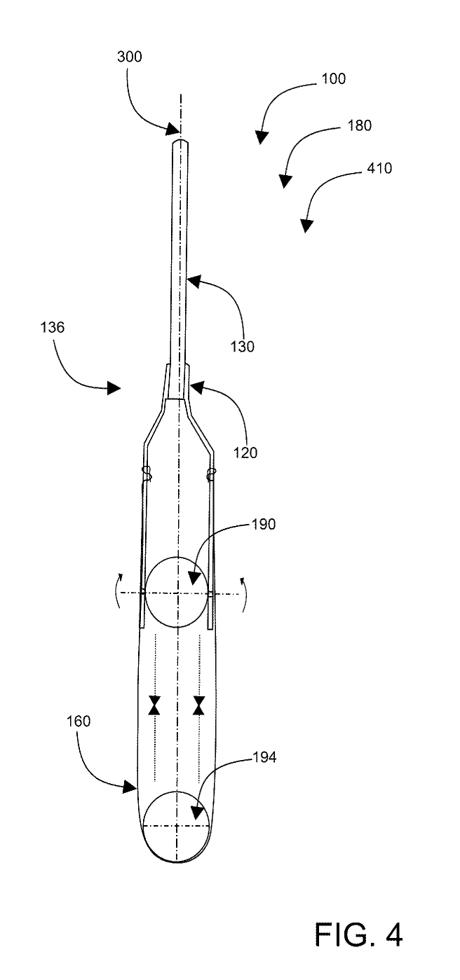

User 170 may wish to remove flexible gate 198 from its coupled relationship to stationary fence 188 to allow ingress or egress for him/her, the animals or equipment. To perform this function moment arm assembly 136 may be rotated from a substantially downward position 132 to a substantially upright position 134, thereby decreasing the tension on cable 160 around flexible gate post 194 and cable 160. Cable 160 may be lifted off flexible gate post 194 to release, thereby creating an available opening. When moment arm assembly 136 is rotated to a horizontal position away from flexible gate post 194, tension on cable 160 is increased. Cable 160 is then tightened around flexible gate post 194 thereby securing flexible gate post 194 to stationary fence end post 190 of stationary fence 188 by drawing them together in a vertical adjacent relationship (also shown in FIG. 4). Moment arm assembly 136 requires a decreased amount of force to move it upwards, because of its lever action creating a force-multiplier. The ease of use and small effort required make the present invention handy for its intended use.

Alternatively, u-shaped member 120 may be coupled to flexible gate post 194 with stationary attacher 110. When moment arm assembly 136 is rotated to a horizontal position away from stationary fence end post 190, tension on cable 160 is increased. Cable 160 is then tightened around stationary fence end post 190 thereby securing flexible gate post 194 to stationary fence end post 190 of stationary fence 188 by drawing them together in a vertical adjacent relationship.

Referring now to FIG. 2 showing perspective views illustrating moment arm assemblies 136 of adjustable gate latching systems 100 according to preferred and alternate embodiments of the present invention of FIG. 1.

As described previously adjustable gate latching systems 100 preferably comprises at least one stationary attacher 110; u-shaped member 120 having at least one aperture 140; lever 130; and cable 160 or chain 158, both embodiment versions shown. It should be noted that other attaching means other than cable and chain may also be used and would still be considered within the scope of the present invention. Other suitable alternatives may include rope, wire, and band(s), etc.

The embodiment shown preferably comprises at least one stationary attacher 110, preferably two, more preferably one on each side. Stationary attacher 110 used within the present invention is preferably a nail or lag screw because they are durable, inexpensive and commonly used items within fencing processes. Lag screws are also preferable because they have a greater friction-resistance to being unwontedly pulled out. However, stationary attacher 110 may be comprised of various attaching means, such as other screw-types, pins, hooks, staples, etc.

U-shaped member 120, as shown may be a flat-iron piece of metal, which is approximately 1″ wide. Alternately, U-shaped member 120 may comprise other tubing or other suitable profiles and be made of other materials that are durable and weatherproof, such as steel, stainless steel, aluminum, braided steel, non-ferrous and ferrous materials; composites, etc.

Lever 130 is typically approximately 1″ in diameter, as mentioned and may be made of a round steel pipe providing a comfortable grip-fit for user 170. However, lever 130 may also be comprised of any suitable material that is durable and weatherproof, such as steel, stainless steel, aluminum, etc. Lever 130 may be welded or otherwise attached to the top of u-shaped member 120. In this way moment arm assembly 136 comprises a moment arm sufficiently durable and effective in use to reduce the amount of effort required to open and/or close flexible gate 198. In the embodiment shown stationary attacher 110 must be at least 2″ higher than cable 160 (or chain 158) when attached to stationary fence end post 190 to ensure sufficient lock-down.

Referring now to FIGS. 3A & 3B, perspective views illustrating u-shaped members 120 with apertures 140 according to embodiments of the present invention of FIG. 1.

As described previously, adjustable gate latching systems 100 preferably comprises u-shaped member 120 including first symmetrical portion 150 and second symmetrical portion 152 with stationary attacher 110 having apertures 140 and cable 160, cable 160 comprising first cable end 162 and second cable end 164.

U-shaped member 120 comprises center-line axis 300, as shown in FIGS. 2 and 4. Center-line axis 300 preferably is an invisible linear extension of lever 130 that is perpendicularly orientated to vertical center-line axis 310 (shown in FIG. 1) of stationary fence end post 190, as also alluded to in FIG. 4. First symmetrical portion 150 and second symmetrical portion 152 of u-shaped member 120 comprise at least two, preferably three apertures 140 in the embodiment shown, having a mirrored equi-distant relationship to stationary attacher 110. Apertures 140 each comprise three through holes separated by a distance of approximately 1″. To provide enablement threading of cable 160 is shown in FIG. 3B and placement of chain 158 over a bolt head is shown in FIG. 3A.

In order to secure flexible gate 198 to stationary fence 188 first cable end 162 and second cable end 164 may be looped through aperture(s) 140 located on each of first symmetrical portion 150 and second symmetrical portions 152 of u-shaped member 120 to create an anchoring means. Cable 160 may be wrapped around flexible gate post 194. Thin flexible cable 160 is preferably made of ferrous or non-ferrous material sufficiently durable to avoid fatigue wear, thereby making it reliable and cost-effective in use. However, cable 160 may be comprised of other suitable material(s) and/or coatings that are flexible and resilient, such as nylon, rubber, etc. Cable 160 may also comprise a chain 158 in certain alternate embodiments, also described in greater detail herein. Cable 160 is typically about 54″ in length, however cable 160 may be shorter or longer depending on the size of flexible gate post 194 and stationary fence end post 190 and desired tightness/looseness of gate coupling.

When moment arm assembly 136 is moved to upright position 134, cable 160 may be also looped around flexible gate post 194. First cable end 162 may be secured to u-shaped member 120 and second cable end 164 may be removably adjusted then secured by increasing or decreasing the length, which may be accomplished by passing/pulling cable 160 through aperture(s) 140 in the side of u-shaped member 120. The length of cable 160 may be easily adjusted to achieve the desired tightness between stationary fence end post 190 and flexible gate post 194, in this way. Cable 160 may be looped through aperture 140. Securing means may comprise a knotted loop as also shown in FIG. 2. When moment arm assembly 136 is brought to downward position 132 and away from flexible gate post 194, the tension on cable 160 is increased, cable 160 is tightened around flexible gate post 194 and flexible gate post 194 is thereby secured. Moment arm assembly 136 may be lifted to re-adjust cable 160 to increase tightness if cable 160 is too loose which would create a danger that animals may escape from within stationary fence 188.

Cable 160 may be secured to u-shaped member 120 in such a position that when u-shaped member 120 is in in-use condition 180 (closed position), apertures 140 for cable 160 are lower than stationary attachers 110 that secure u-shaped member 120 to stationary fence end post 190. This will effectively lock moment arm assembly 136 in a downward position 132 and require an increased amount of force (via camming means) to move moment arm assembly 136 up and off-center to open flexible gate 198. When aperture(s) 140 receive cable 160, specifically aperture 140 that cable 160 is threaded into first (and is closest to the gate 198) is lower than stationary attacher 110 it comprises a shorter distance then when it is horizontal. This provides gate latching systems 100 the “locking means”, this being the point where a only small pressure/force is required to lift lever 130 and in effect pull flexible gate post 190 of flexible gate 188 closer to stationary fence end post 194.

When moment arm assembly 136 is moved to an upright position 134 in an effort to open flexible gate 198, the tension on cable 160 is decreased around flexible gate post 194 and cable 160 is elevated above and from around flexible gate post 194 thereby permitting flexible gate post 194 to become uncoupled from stationary fence end post 190. Alternatively, cable 160 may be removed from aperture(s) 140 thereby permitting flexible gate post 194 to be uncoupled from stationary fence end post 190.

Referring now to FIG. 4, showing a top perspective view illustrating adjustable gate latching systems 100 in closed condition 410 according to an embodiment of the present invention of FIG. 1.

When moment arm assembly 136 is brought to downward position 132, as shown, cable 160 is preferably tightened around flexible gate post 194 and the flexible gate post 194 is brought adjacent to the stationary fence end post 190. In this way flexible gate 198 is coupled to stationary fence 188 in closed condition 410. In an open condition flexible gate 198 may be laid on the ground in a horizontal position.

Adjustable gate latching system 100 may be sold as kit 440 comprising the following parts: at least one stationary attacher 110; at least one u-shaped member 120; at least one aperture 140; at least one lever 130; at least one cable 160 and/or chain 158 and optionally at least one set of user instructions. Adjustable gate latching system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different and/or more nuts, bolts and lock washers, parts may be sold separately, etc., may be sufficient.

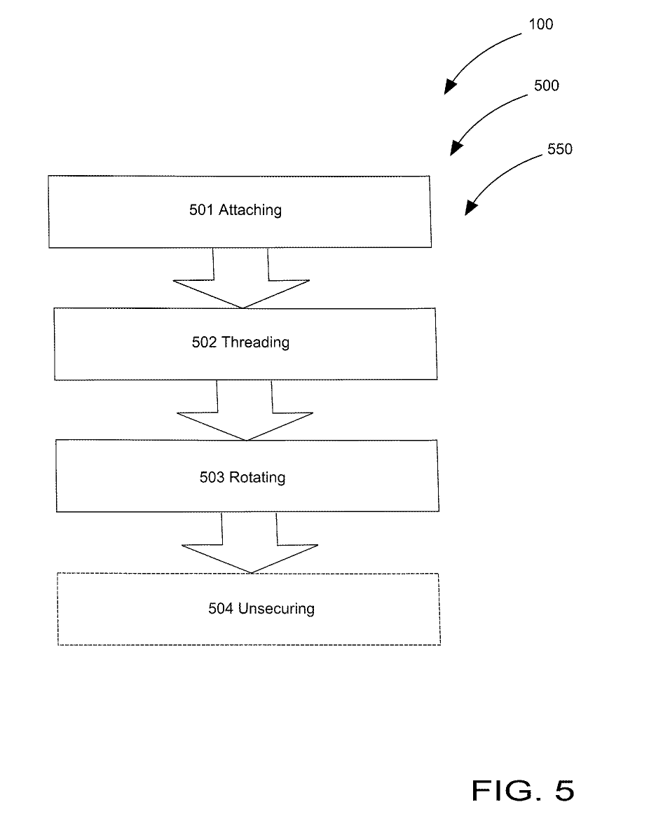

Referring now to FIG. 5, flowchart 550 illustrating a method of use 500 for adjustable gate latching system 100 according to an embodiment of the present invention of FIGS. 1-4.

A method 500 of using gate latching system 100 for securing flexible gate post 194 to stationary fence end post 190 comprising the steps of: step one 501 attaching moment arm assembly 136 including a lever 130 and a u-shaped member 120 to a stationary fence end post 190 via stationary attachers 110; step two 502 threading a cable 160 through at least one aperture 140 located on u-shaped member 120 to form an anchor means; step three 503 rotating moment arm assembly 136 about stationary attacher 110 to tighten cable 160 bringing flexible gate post 194 adjacent to stationary fence end-post 190 thereby closing a fencing perimeter.

The method of using the adjustable gate latching system 100 may further include step four 504 to unsecure a flexible gate post 194 from a stationary fence end post 190 by rotating moment arm assembly 136 about stationary attacher 110 to loosen cable 160 withdrawing flexible gate post 194 from adjacent stationary fence end-post 190 thereby opening fencing perimeter.

It should be noted that step 504 is an optional step and may not be implemented in all cases. Optional steps of method 500 are illustrated using dotted lines in FIG. 5 so as to distinguish them from the other steps of method 500. Method 500 may also be incorporated for use using chain 158, as described above.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A gate latching system comprising:
at least one stationary attacher;
a u-shaped member including two symmetrical portions having at least one aperture located through each of said symmetrical portions;
a lever; and
a flexible cable comprising two ends;
wherein said flexible cable is looped through said at least one aperture as a tightening means for securing a flexible gate to a stationary fence;
wherein said lever is coupled to said u-shaped member for rotating about said at least one stationary attacher used to couple said u-shaped member to said stationary fence.

2. The gate latching system of claim 1 wherein said at least one stationary attacher comprises at least one nail.

3. The gate latching system of claim 1 wherein said u-shaped member and said lever comprise a moment arm assembly.

4. The gate latching system of claim 3 wherein said moment arm assembly is rotatable downwardly about said stationary attacher to increase tension on said flexible cable.

5. The gate latching system of claim 3 wherein said moment arm assembly is rotatable upwardly about said stationary attacher to decrease tension on said flexible cable.

6. The gate latching system of claim 1 wherein said cable is looped through said at least one aperture located on each of said two symmetrical portions located on said u-shaped member to create an anchoring means.

7. The gate latching system of claim 1 wherein said cable comprises a chain.

8. The gate latching system of claim 1 wherein said u-shaped member comprises a center-line axis as an extension of said lever that is perpendicularly orientated to a vertical center-line axis of stationary fence end-post.

9. The gate latching system of claim 8 wherein said each of said two symmetrical portions comprise two apertures having an equi-distant relationship to said stationary attacher.

10. The gate latching system of claim 6 wherein one of said cable ends is removable from said aperture(s) thereby permitting said flexible gate to be uncoupled from said stationary fence.

11. The gate latching system of claim 6 wherein said flexible cable is elevated above and from around said stationary fence end-post thereby permitting said flexible gate to be uncoupled from said stationary fence.

12. A gate latching system comprising:
at least one stationary attacher comprising a nail;
a u-shaped member including two symmetrical portions having a plurality of apertures located through each of said symmetrical portions;
a lever;
a cable comprising two ends;
wherein said u-shaped member and said lever comprise a moment arm assembly;
wherein said moment arm assembly is rotatable about said stationary attachers located on each side of said u-shaped member to couple said gate latching system to a stationary fence as a means to decrease or increase tension on said cable;
wherein said cable is looped through said at least one aperture as a tightening means for securing a flexible gate to said stationary fence;
wherein said u-shaped member comprises a center-line axis as an extension of said lever that is perpendicularly orientated to a vertical center-line axis of stationary fence end-post;
wherein said lever is coupled to said u-shaped member for rotating about said at least one stationary attacher used to couple said u-shaped member to said stationary fence.

13. The gate latching system of claim 12 wherein said gate latching system comprises a kit including said moment arm assembly, at least two stationary attachers, said cable and a user instruction manual.

14. A method of using a gate latching system to secure a flexible gate to a stationary fence comprising the steps of:
attaching a moment arm assembly including a lever and a u-shaped member to a flexible gate post via stationary attachers;
threading a cable through at least one aperture located on said u-shaped member to form an anchor means;
rotating said moment arm assembly about said attacher to tighten said cable bringing said flexible gate post adjacent to a stationary fence end-post thereby closing a fencing perimeter.

15. The method of using the gate latching system of claim 14 to unsecure a flexible gate from a stationary fence by rotating said moment arm assembly about said attacher to loosen said cable withdrawing said flexible gate post from adjacent said stationary fence end-post thereby opening said fencing perimeter.

16. The method of using a gate latching system of claim 14 wherein a chain is used to replace said cable in conjunction with said lever and said u-shaped member to tighten said flexible gate to said stationary fence.

17. The method of using a gate latching system of claim 16 wherein said chain is removably secured over a specialty bolt head.
